(19) United States
(12) Patent Application Publication
(10) Pub. No.: US 2021/0149880 A1
(43) Pub. Date: May 20, 2021

(54) SYSTEMS AND METHODS FOR EXTENDABLE SMART CONTRACTS IN DISTRIBUTED LEDGER TECHNOLOGY

(71) Applicant: Insolar Technologies GmbH, Steinhausen (CH)

(72) Inventors: Kirill Ivkushkin, Moscow (RU); Vladimir Stepanov, Moscow (RU); Andrei Zhulin, Moscow (RU)

(21) Appl. No.: 16/952,284

(22) Filed: Nov. 19, 2020

Related U.S. Application Data
(60) Provisional application No. 62/937,881, filed on Nov. 20, 2019.

(51) Int. Cl. G06F 16/23; G06Q 10/10; G06F 16/27

(52) U.S. Cl. CPC G06F 16/2379; G06Q 10/10; G06Q 20/389; G06F 16/2365; G06F 16/27

(57) ABSTRACT

Disclosed herein are methods and systems for updating smart contract functionality in a blockchain network. In one exemplary aspect, a method may comprise identifying, by an execution environment, an original smart contract stored on the blockchain network. The method may comprise uploading an extension smart contract amending functionality of the original smart contract onto the blockchain network, wherein the extension smart contract does not change the original smart contract. In response to detecting a call to the original smart contract, wherein the call comprises an attribute and method associated with an object, the method may comprise determining whether the attribute and the method are of the extension smart contract. In response to determining that the attribute and the method of the object are of the extension smart contract, the method may comprise calling the extension smart contract instead of the original smart contract, and executing the extension smart contract.

### CROSS-REFERENCE TO RELATED APPLICATIONS

This application claims the benefit of U.S. Provisional Application No. 62/937,881, filed Nov. 20, 2019, which is herein incorporated by reference.

### FIELD OF TECHNOLOGY

The present disclosure relates generally to the field of distributed ledger technology (DLT), more specifically, to systems and methods for extending the functionality of smart contracts.

### BACKGROUND

In DLT and blockchain systems, when smart contracts are created, they are set to execute upon certain set conditions. However, if there is a change in situation and the smart contract needs to be amended to execute in a different way, a completely new contract must be created. Over time, the developer of an original smart contract may become unavailable, or may be unwilling to make changes. Thus there is a need to facilitate extension of the original functionality that would not involve the original developer and/or would not change the original smart contract.

### SUMMARY

To address this need, aspects of the disclosure describe methods and systems for updating smart contract functionality in a blockchain network. In one exemplary aspect, a method may comprise identifying, by an execution environment, an original smart contract stored on the blockchain network. The method may comprise uploading an extension smart contract amending functionality of the original smart contract onto the blockchain network, wherein the extension smart contract does not change the original smart contract. In response to detecting a call to the original smart contract, wherein the call comprises an attribute and method associated with an object, the method may comprise determining whether the attribute and the method are of the extension smart contract. In response to determining that the attribute and the method of the object are of the extension smart contract, the method may comprise calling the extension smart contract instead of the original smart contract, and executing the extension smart contract.

In some aspects, the method may further comprise generating the original smart contract such that the original smart contract supports delegation constructs, wherein the original smart contract delegates execution of the method to the extension smart contract.

In some aspects, the execution environment supports an Interface Definition Language (IDL), allowing an invocation of either the original smart contract or the extension smart contract based on a particular interface definition employed, the attribute, and the method of the call.

In some aspects, the original smart contract is written in a first programming language and the extension smart contract is written in a second programming language.

In some aspects, the extension smart contract is comprised in a plurality of extension smart contracts that each uniquely modify functionality of the original smart contract.

In some aspects, the plurality of extension smart contracts are a chain of extension smart contracts that delegate to each other.

In some aspects, the method may further comprise calling the extension smart contract instead of the original smart contract further in response to determining that the attribute and the method are not of the original smart contract.

In some aspects, the method may further comprise calling the extension smart contract instead of the original smart contract further in response to determining that a time period for executing the original smart contract has expired.

It should be noted that the methods described above may be implemented in a system comprising a hardware processor. Alternatively, the methods may be implemented using computer executable instructions of a non-transitory computer readable medium.

The above simplified summary of example aspects serves to provide a basic understanding of the present disclosure. This summary is not an extensive overview of all contemplated aspects, and is intended to neither identify key or critical elements of all aspects nor delineate the scope of any or all aspects of the present disclosure. Its sole purpose is to present one or more aspects in a simplified form as a prelude to the more detailed description of the disclosure that follows. To the accomplishment of the foregoing, the one or more aspects of the present disclosure include the features described and exemplarily pointed out in the claims.

### BRIEF DESCRIPTION OF THE DRAWINGS

The accompanying drawings, which are incorporated into and constitute a part of this specification, illustrate one or more example aspects of the present disclosure and, together with the detailed description, serve to explain their principles and implementations.

FIG. 1 is a block diagram of a system for maintaining and storing a distributed ledger of records, according to an exemplary aspect.

FIG. 2 is a block diagram of a system for executing a smart contract, according to an exemplary aspect.

FIG. 3 is a flow diagram of a method for making changes in a smart contract without changing the initial smart contract code in a blockchain network, according to exemplary aspects of the present disclosure.

FIG. 4 is a block diagram of a computer system on which the disclosed system and method can be implemented according to an exemplary aspect.

### DETAILED DESCRIPTION

Exemplary aspects are described herein in the context of a system, method, and computer program product for making changes in a smart contract without changing the initial smart contract code in a blockchain network. Those of ordinary skill in the art will realize that the following description is illustrative only and is not intended to be in any way limiting. Other aspects will readily suggest themselves to those skilled in the art having the benefit of this disclosure. Reference will now be made in detail to implementations of the example aspects as illustrated in the accompanying drawings. The same reference indicators will be used to the extent possible throughout the drawings and the following description to refer to the same or like items.

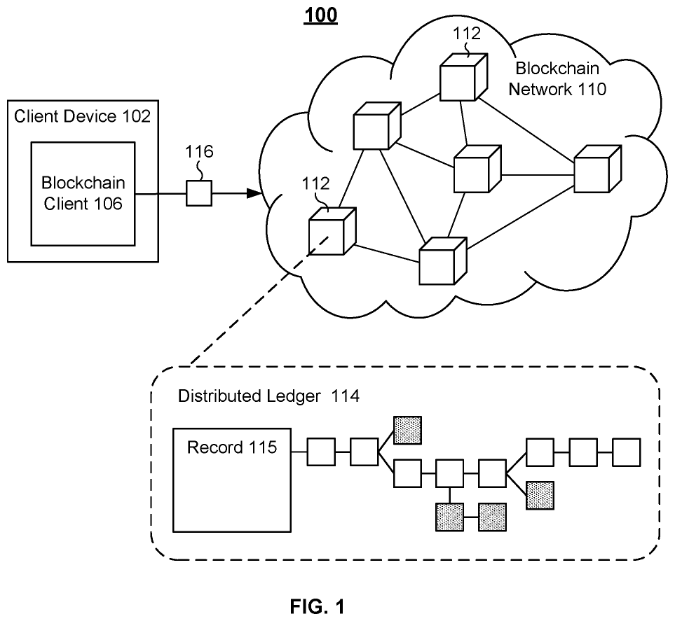

FIG. 1 is a block diagram of system 100 for maintaining and storing a distributed ledger of records, according to an exemplary aspect. System 100 may include one or more client device(s) 102 communicatively connected to blockchain network 110. Client device 102 may be one of personal computers, servers, laptops, tablets, mobile devices, smart phones, cellular devices, portable gaming devices, media players or any other suitable devices that can retain, manipulate and transfer data. Client device 102 may include a blockchain client 106, which is a software application configured to generate and transmit one or more blockchain-based transactions or messages 116 to blockchain network 110 for accessing or modifying records stored in the distributed ledger, such as maintaining user accounts, the transfer of cryptographic assets to and from such user accounts, and other types of operations.

According to an exemplary aspect, blockchain network 110 can be a distributed peer-to-peer network formed from a plurality of nodes 112 (computing devices) that collectively maintain distributed ledger 114, which may contain one or more blockchains 114. For purposes of the present discussion, the terms distributed ledger and blockchain may be interchangeably used. Blockchain 114 is a continuously-growing list of data records hardened against tampering and revision using cryptography and is composed of data structure blocks that hold the data received from other nodes 112 or other client nodes, including the client device 102 executing an instance of the blockchain client 106. The blockchain client 106 is configured to transmit data values to the blockchain network 110 as a transaction data structure 116, and nodes 112 in the blockchain network process, record and validate/confirm when and in what sequence the data transactions enter and are logged in blockchain 114.

The distributed ledger may be organized into multiple blockchains 114 which are configured to ensure chronological and immutable storage of data. In one aspect, the distributed ledger may include one or more lifeline blockchains, sideline blockchains, and jet blockchains. In one implementation, lifeline blockchains are individual blockchains in which each data object and all its states are stored (i.e., objects are treated as individual blockchains). Lifeline blockchains can have logic and code associated with them, so the terms lifeline blockchain, object, and smart contract may be used interchangeably. In one aspect, sideline blockchains are utility lifeline blockchains used to store temporary or auxiliary data such as indexes, pending operations, or debug logs. A lifeline blockchain can have several associated sideline blockchains to store information. A jet blockchain may be configured to act as a shard or partition which make up storage blocks and form shard chains. Records in a jet blockchain may be first produced by a lifeline blockchain, then packaged into blocks, and placed in sequence to form a chain of blocks. Replication and distribution of data can be managed individually by blocks and jet blockchains. The use of multiple kinds of blockchains enables dynamic reconfiguration of storage by splitting and merging of j et blocks without compromising data immutability.

Distributed ledgers (e.g., blockchain 114) are used to store a plurality of records 115, which may contain information such as a request, a response, a control of state, and maintenance details. In known approaches to blockchain technology, records 115 of a distributed ledger are ordered chronologically by time of creation or registration, and each record of a ledger may represent an operation (or a change) made and can have a reference to a previous record which represents a baseline for the operation. The reference uniquely identifies an entity (e.g., record) and is based on or includes information (e.g., checksum, hash, or signature) to validate the integrity of the entity the reference points to. Blockchain 114 is configured such that record 115 contained in the blockchain contains a reference to a previous record and hash information.

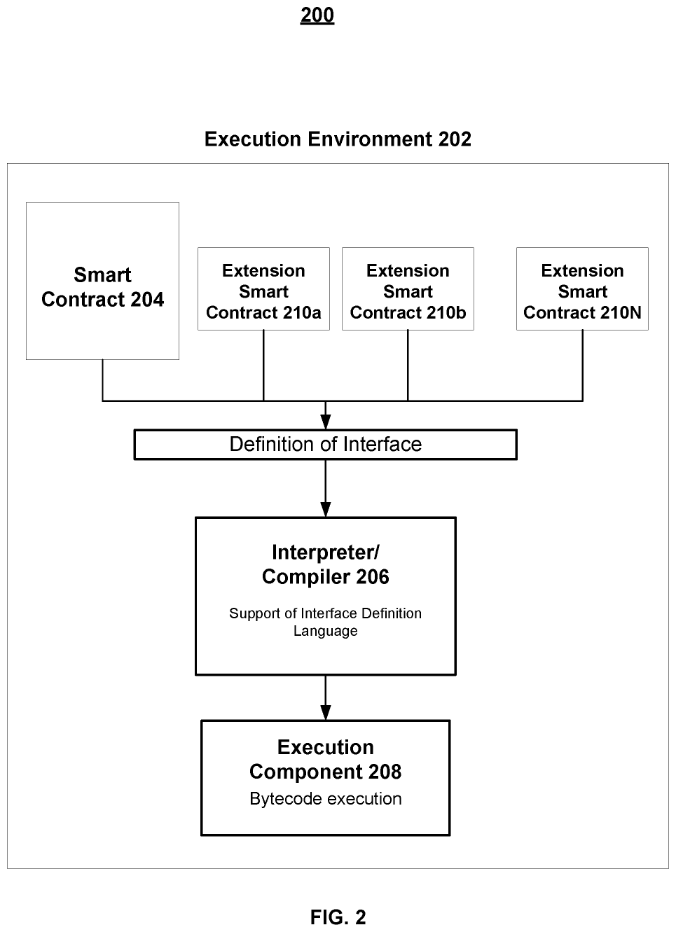

FIG. 2 is a block diagram of system 200 for executing smart contract 204 according to an exemplary aspect. By definition, a smart contract is a self-enforcing agreement that is embedded in code managed by a blockchain network (e.g., blockchain network 110). From a high level, the code comprises one or more rules by which parties conducting a transaction agree to interact under. An agreement is automatically enforced, if and when the one or more rules are satisfied.

More technically, a smart contract is a computer code intended to digitally facilitate execution (e.g., by processing or validation) of any operation regarding changing of an object state (e.g., a transaction changing the object). Smart contracts enable rich logic to be applied to an object or a set of objects. A smart contract is stored on blockchain network 110 and is accessible to nodes 112. Whenever a transaction happens, a function calls the smart contract to perform processing.

As mentioned previously, the conditions of a smart contract may be subject to change. In order to establish new conditions, conventionally, a brand new smart contract is generated and stored on blockchain network 110, along with all previous versions of the smart contract. Because the previous versions of the smart contract are not utilized, the previous versions are simply superfluous and take up space unnecessarily on network 110. In another approach, an original smart contract may be rewritten. However, over time, the original developer of the original smart contract may become unavailable, or may be unwilling to make changes. Thus there is a need to facilitate extension of the original functionality that would not involve the original developer. Not to mention, some changes may not be large or drastic, and thus rewriting the original smart contract only expends time and resources inefficiently.

The present disclosure discusses a system and method for updating a particular functionality of smart contracts or adding a new functionality to smart contracts, rather than generating new smart contracts with full new functionality from scratch. In an exemplary aspect, this is done via implementing (outside of the blockchain) a new smart contract with required functionality and employing the platform mechanism of call routing (also referred to as “dereferencing” and “delegating”) so that the new contract is called whenever a particular functionality of the old contract is invoked. For example, a function in a smart contract may be updated and included in an “extension” smart contract. Whenever the function is invoked, the updated function in the extension smart contract may be utilized instead of the original function in the old contract. In other aspects, an existing smart contract may be injected with new code to extend and/or replace the functionality of the existing contract without involvement of developers of the original code.

The systems and methods of the present disclosure can be implemented on DLT platforms where new behavior (e.g., new regulations, change in regulation/corporate policies, etc.) needs to be added without fully rewriting and changing the original smart contract.

The systems and methods can also be implemented in a scenario where users of the DLT platform may wish to scale blockchain network 110 by building upon some functionality to smart contracts, but the original developer may not be working on the network. In this instance, third-party developers may be engaged using the mechanisms discussed in the present disclosure to deploy their code.

Consider an example in which a smart contract exists between two companies with a length of agreement set at twenty years. During this time, internal corporate policies, regulations and conditions may change. The systems and methods of the present disclosure allow to avoid large scale changes to the source code. A reference to each smart contract is created at the conception of every smart contract and the reference remains the same throughout the smart contract's lifetime. In this instance, the reference to the initial smart contract can be used to find and identify a smart contract and carry out updates. For the companies to use amended contracts, an extension smart contract is created, registered, and has its reference identified.

Referring to FIG. 2, execution environment 202 may be a virtual machine, a container, or an operating system of node 112. Smart contract 204 resides on blockchain network 110 (e.g., on-chain or off-chain), which provides execution environment 202. Smart contract 204 represents the original smart contract. Extension smart contracts 210 (a-N) represent individual smart contracts that modify/add functionality of smart contract 204 and/or each other. Execution environment 202 also comprises interpreter/compiler 206 and execution component 208.

In order to analyze and execute smart contract 204, execution environment 202 is configured to support Interface Definition Language (IDL) and support the uploading of extension smart contracts. More specifically, the present disclosure utilizes execution environment 202 with blocks which can interpret the language of a smart contract including the support for IDL. IDL is a specification language used to describe the application programming interface (API) of a software component in a language-independent way. IDL thus enables communication between software components that do not share one language. For example, one software component written in C++ may be able to communicate with a software component written in Java, using an IDL. At the smart contract level, an IDL is implemented to declare and support delegation constructs. Thus, even if an original smart contract is written in a particular language and an extension smart contract is written in a different language, the IDL serves as a bridge by supporting delegation constructs.

It should be noted that the smart contract's interface is configured to support the declaration of delegation methods and their implementation. In some aspects, the mechanism for calling an extension smart contract and uploading new code is based on the delegation pattern mechanism. A delegation pattern is an object-oriented design pattern that allows object composition to achieve the same code reuse as inheritance. When using a delegation pattern mechanism, an original smart contract would thus stay the same, but would provide means to call the new code (i.e., in the extension smart contract) and the platform would provide means to upload and execute the new code. The new code of the extension smart contact may, for example, create a sub-class that inherits most fields/methods from its parent class (e.g., in the code of the original smart contract). The sub-class may add new fields/methods or modify existing fields/methods in the parent class.

In an exemplary aspect, the addressing mechanism is such that a smart contract instance has a unique address in blockchain 114 that does not change with time regardless of an object's code or changes in the object's state. Both may be changed, but the address stays the same.

In an exemplary aspect, execution environment 202 is configured to support the translation of definitions into executable code, and correctly route calls to a smart contract that existed before the update or to the extension smart contract depending on the context. In terms of context, either the methods (e.g., functions) of the original contract are invoked, or the extension contract's methods are invoked (i.e., execution environment 202 supports execution of both original and extension contract).

In reference to system 200, the algorithm associated with the present disclosure begins with the definition of the interface of the original smart contract. An interface defines a set of methods that an instance of a class with the interface may respond to. In particular, an interface definition that supports delegation is identified.

The interpreter/compiler of execution environment 202 is configured to support IDL. DLT platforms can support many languages, for each language it would be required to support IDL and delegations (execution, etc.). A mechanism is thus provided for uploading new code (i.e., a need for special contracts in various programming languages which are utilized on the DLT platform). Execution component 208 may then invoke and execute the updated logic (e.g., the delegated code). In some aspects, execution component 208 may execute the code of the original smart contract instead of the code of an extension contract.

Suppose that two companies perform a monthly transaction. Company A is to transfer $100,000 to company B at the beginning of every month (e.g., in a licensing deal). Smart contract A verifies whether the originating bank account of company A has $100,000 and whether it is the first of a month. If those two criteria are met, the transaction is executed.

Companies A and B subsequently agree that smart contract A should be amended to verify whether a total amount in the bank account of company A exceeds $1 million. If company A does not have at least this total amount, the transfer is delayed by 1 week. In the present disclosure, rather than creating a new smart contract and not utilizing smart contract A any longer (leaving it superfluous), an extension of smart contract A (i.e., smart contract B) is created. In some aspects, smart contract B is written such that it creates a sub-class that inherits most fields and methods from its parent class of smart contract A. Smart contract B may include a new method, for example, that determines whether the balance in the bank account of company A exceeds $1 million. Alternatively, smart contract B may modify an original method in smart contract A (e.g., a method that previously assessed whether there are $100,000 in the bank account of company A) to now further assess whether there are a total of $1 million in the bank account. It should be noted that when smart contract A is written, an interface is provided to allow smart contract A to delegate execution to smart contract B. This is because, in some aspects, smart contract A calls smart contract B through the interface.

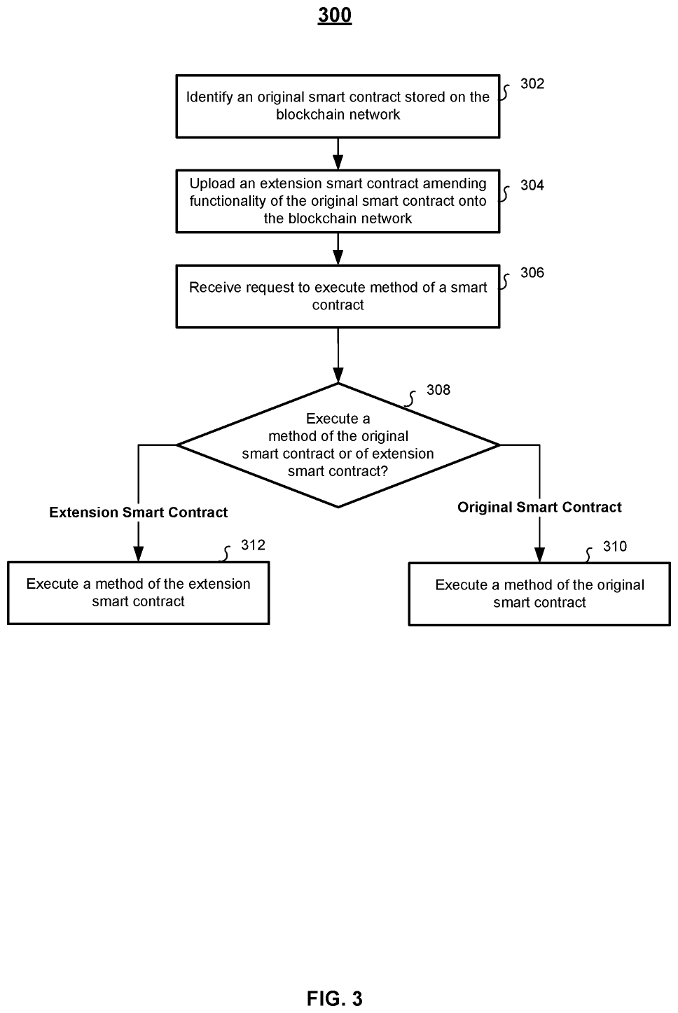

FIG. 3 is a flow diagram of method 300 for making functionality changes for a smart contract without changing the initial smart contract code in a blockchain network, according to exemplary aspects of the present disclosure.

At 302, execution environment 202 (e.g., a virtual machine) identifies an original smart contract stored on blockchain network 110. For example, the original smart contract may be configured to perform task X if a requirement Y is met. At 304, execution environment 202 uploads an extension smart contract amending functionality of the original smart contract to the blockchain network 110. For example, execution environment 202 allows for the amendments of the programming code of the original smart contract such that task X is performed if requirement Y and a new requirement Z are met. It should be noted that the extension smart contract does not in fact replace the smart contract in blockchain network 110.

At 306, execution environment 202 detects a trigger of a smart contract process. The smart contract process is the verification of whether the requirements of a smart contract are met. The trigger may be a transaction, an addition of a new record 115 on blockchain 114, a validation, etc. Specifically, execution environment 202 receives a request (e.g., from a node in the blockchain network) to execute a method of a smart contract. The request may further include an attribute of an object. The object, method, and attribute in this context correspond to an object, method, and attribute in object-oriented programming, i.e., a method is a function called on an object of some class, and an attribute corresponds to the field (e.g., variable) of the object. Referring to the previous example, the request may be to execute the method that verifies whether company A has $1 million in their bank account.

At 308, execution environment 202 determines whether to execute a method of the original smart contract or a method of the extension smart contract based on analyzing the attribute and the method of the request. Specifically, the request is dereferenced by execution environment 202 to determine a particular instance of the smart contract that should be invoked (i.e., a reference may point to the extension smart contract and method name will remain the same). In response to determining that a method of the original smart contract should be executed, method 300 ends at 310, where execution environment 202 executes the method of the original smart contract (i.e., to determine whether requirement Y is met and perform task X accordingly). If at 308, execution environment 202 determines that the method of the extension smart contract should be executed, method 300 advances to 312, where execution environment 202 executes the method of the extension smart contract (i.e., to determine whether requirements Y and Z are met and perform task X accordingly).

Consider an example of payment conditions for a master agreement of the International Swaps and Derivatives Association (ISDA). New methods of payment with arbitrary complex conditions may need to be introduced and accordingly, an addendum is made to the original smart contract realizing the master agreement—thus creating an extension contract. This way, the original ISDA agreement will stay the same (e.g. counterparties will still trade the same spectra of financial instruments), but the specific methods of transfer will be provided only by the extension contract. The caller may invoke the original contract by reference (e.g., by passing a method name), but a new payment method identified in the extension contract may be used. In response, the platform mechanism may determine that the new payment method does not exist on the original contract and the extension contract must be called.

In another example where time dictates which contract to invoke, consider over-the-counter (OTC) swap trades with conditions of fix versus floating payment. An extension smart contract may comprise a change in percentage/fix ratio and a change in payout currencies. The fluency feature may provide different implementations of the existing payment schedule methods: the same method would be called on the original contract (reference and method name), but starting from a particular date, the method of the extension contract will be invoked. Here, even if the method and attribute of the original smart contract are called, in response to determining that a time period for executing the original smart contract has expired, the extension smart contract is called instead (particularly to execute a corresponding method, e.g., that shares the same name).

The advantages of the systems and methods described in the present disclosure include allowing to update existing smart contracts via a discovery system which assigns reference numbers. This helps to address the issue of contracts that become superfluous and may result in the clogging up of the network. In existing blockchains, if a modification to a smart contract is needed, a new smart contract must be deployed. Thus, another advantage to this method is that small changes can be made to existing contracts instead of having to create new smart contracts from scratch. There may be a plurality of extension smart contracts (e.g., 210a, b, N) that each uniquely modify functionality of the original smart contract (e.g., 204). Each extension smart contract would serve its own purpose without leaving the original smart contract as being superfluous. In some aspects, there may be a chain of extension smart contracts that can delegate to each other (e.g., a parent extension smart contract delegating to a child extension smart contract). In this scenario, the parent extension smart contract is treated like an original smart contract relative to the child extension smart contract.

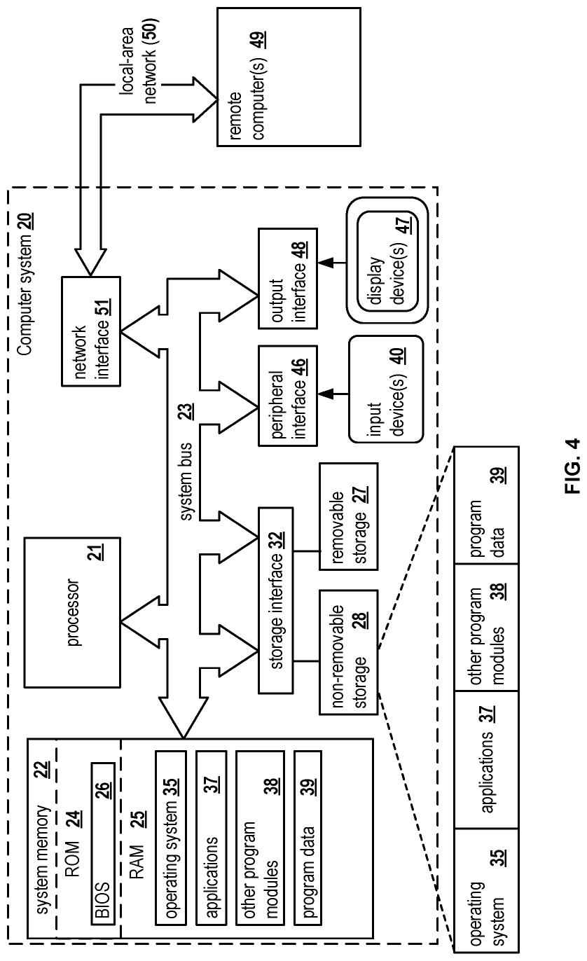

FIG. 4 is a block diagram illustrating a computer system 20 on which aspects of systems and methods for updating a smart contract may be implemented in accordance with an exemplary aspect. It should be noted that the computer system 20 could correspond to the client device 102, for example, described earlier. The computer system 20 can be in the form of multiple computing devices, or in the form of a single computing device, for example, a desktop computer, a notebook computer, a laptop computer, a mobile computing device, a smart phone, a tablet computer, a server, a mainframe, an embedded device, and other forms of computing devices.

As shown, the computer system 20 includes a central processing unit (CPU) 21, a system memory 22, and a system bus 23 connecting the various system components, including the memory associated with the central processing unit 21. The system bus 23 may comprise a bus memory or bus memory controller, a peripheral bus, and a local bus that is able to interact with any other bus architecture. Examples of the buses may include PCI, ISA, PCI-Express, Hyper Transport™, InfiniBand™, Serial ATA, I²C, and other suitable interconnects. The central processing unit 21 (also referred to as a processor) can include a single or multiple sets of processors having single or multiple cores. The processor 21 may execute one or more computer-executable code implementing the techniques of the present disclosure. The system memory 22 may be any memory for storing data used herein and/or computer programs that are executable by the processor 21. The system memory 22 may include volatile memory such as a random access memory (RAM) 25 and non-volatile memory such as a read only memory (ROM) 24, flash memory, etc., or any combination thereof. The basic input/output system (BIOS) 26 may store the basic procedures for transfer of information between elements of the computer system 20, such as those at the time of loading the operating system with the use of the ROM 24.

The computer system 20 may include one or more storage devices such as one or more removable storage devices 27, one or more non-removable storage devices 28, or a combination thereof. The one or more removable storage devices 27 and non-removable storage devices 28 are connected to the system bus 23 via a storage interface 32. In an aspect, the storage devices and the corresponding computer-readable storage media are power-independent modules for the storage of computer instructions, data structures, program modules, and other data of the computer system 20. The system memory 22, removable storage devices 27, and non-removable storage devices 28 may use a variety of computer-readable storage media. Examples of computer-readable storage media include machine memory such as cache, static random access memory (SRAM), dynamic random access memory (DRAM), zero capacitor RAM, twin transistor RAM, enhanced dynamic random access memory (eDRAM), extended data output random access memory (EDO RAM), double data rate random access memory (DDR RAM), electrically erasable programmable read-only memory (EEPROM), NRAM, resistive random access memory (RRAM), silicon-oxide-nitride-silicon (SONOS) based memory, phase-change random access memory (PRAM); flash memory or other memory technology such as in solid state drives (SSDs) or flash drives; magnetic cassettes, magnetic tape, and magnetic disk storage such as in hard disk drives or floppy disks; optical storage such as in compact disks (CD-ROM) or digital versatile disks (DVDs); and any other medium which may be used to store the desired data and which can be accessed by the computer system 20.

The system memory 22, removable storage devices 27, and non-removable storage devices 28 of the computer system 20 may be used to store an operating system 35, additional program applications 37, other program modules 38, and program data 39. The computer system 20 may include a peripheral interface 46 for communicating data from input devices 40, such as a keyboard, mouse, stylus, game controller, voice input device, touch input device, or other peripheral devices, such as a printer or scanner via one or more I/O ports, such as a serial port, a parallel port, a universal serial bus (USB), or other peripheral interface. A display device 47 such as one or more monitors, projectors, or integrated display, may also be connected to the system bus 23 across an output interface 48, such as a video adapter. In addition to the display devices 47, the computer system 20 may be equipped with other peripheral output devices (not shown), such as loudspeakers and other audiovisual devices

The computer system 20 may operate in a network environment, using a network connection to one or more remote computers 49. The remote computer (or computers) 49 may be local computer workstations or servers comprising most or all of the aforementioned elements in describing the nature of a computer system 20. Other devices may also be present in the computer network, such as, but not limited to, routers, network stations, peer devices or other network nodes. The computer system 20 may include one or more network interfaces 51 or network adapters for communicating with the remote computers 49 via one or more networks such as a local-area computer network (LAN) 50, a wide-area computer network (WAN), an intranet, and the Internet. Examples of the network interface 51 may include an Ethernet interface, a Frame Relay interface, SONET interface, and wireless interfaces.

Aspects of the present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store program code in the form of instructions or data structures that can be accessed by a processor of a computing device, such as the computing system 20. The computer readable storage medium may be an electronic storage device, a magnetic storage device, an optical storage device, an electromagnetic storage device, a semiconductor storage device, or any suitable combination thereof. By way of example, such computer-readable storage medium can comprise a random access memory (RAM), a read-only memory (ROM), EEPROM, a portable compact disc read-only memory (CD-ROM), a digital versatile disk (DVD), flash memory, a hard disk, a portable computer diskette, a memory stick, a floppy disk, or even a mechanically encoded device such as punch-cards or raised structures in a groove having instructions recorded thereon. As used herein, a computer readable storage medium is not to be construed as being transitory signals per se, such as radio waves or other freely propagating electromagnetic waves, electromagnetic waves propagating through a waveguide or transmission media, or electrical signals transmitted through a wire.

Computer readable program instructions described herein can be downloaded to respective computing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network interface in each computing device receives computer readable program instructions from the network and forwards the computer readable program instructions for storage in a computer readable storage medium within the respective computing device.

Computer readable program instructions for carrying out operations of the present disclosure may be assembly instructions, instruction-set-architecture (ISA) instructions, machine instructions, machine dependent instructions, microcode, firmware instructions, state-setting data, or either source code or object code written in any combination of one or more programming languages, including an object oriented programming language, and conventional procedural programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or WAN, or the connection may be made to an external computer (for example, through the Internet). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

In various aspects, the systems and methods described in the present disclosure can be addressed in terms of modules. The term “module” as used herein refers to a real-world device, component, or arrangement of components implemented using hardware, such as by an application specific integrated circuit (ASIC) or FPGA, for example, or as a combination of hardware and software, such as by a microprocessor system and a set of instructions to implement the module's functionality, which (while being executed) transform the microprocessor system into a special-purpose device. A module may also be implemented as a combination of the two, with certain functions facilitated by hardware alone, and other functions facilitated by a combination of hardware and software. In certain implementations, at least a portion, and in some cases, all, of a module may be executed on the processor of a computer system (such as the one described in greater detail in FIG. 5, above). Accordingly, each module may be realized in a variety of suitable configurations, and should not be limited to any particular implementation exemplified herein.

In the interest of clarity, not all of the routine features of the aspects are disclosed herein. It would be appreciated that in the development of any actual implementation of the present disclosure, numerous implementation-specific decisions must be made in order to achieve the developer's specific goals, and these specific goals will vary for different implementations and different developers. It is understood that such a development effort might be complex and time-consuming, but would nevertheless be a routine undertaking of engineering for those of ordinary skill in the art, having the benefit of this disclosure.

Furthermore, it is to be understood that the phraseology or terminology used herein is for the purpose of description and not of restriction, such that the terminology or phraseology of the present specification is to be interpreted by the skilled in the art in light of the teachings and guidance presented herein, in combination with the knowledge of the skilled in the relevant art(s). Moreover, it is not intended for any term in the specification or claims to be ascribed an uncommon or special meaning unless explicitly set forth as such.

The various aspects disclosed herein encompass present and future known equivalents to the known modules referred to herein by way of illustration. Moreover, while aspects and applications have been shown and described, it would be apparent to those skilled in the art having the benefit of this disclosure that many more modifications than mentioned above are possible without departing from the inventive concepts disclosed herein.

What is claimed is:

1. A method for updating smart contract functionality in a blockchain network, the method comprising:
identifying, by an execution environment, an original smart contract stored on the blockchain network;
uploading an extension smart contract amending functionality of the original smart contract onto the blockchain network, wherein the extension smart contract does not change the original smart contract;
in response to detecting a call to the original smart contract, wherein the call comprises an attribute and method associated with an object, determining whether the attribute and the method are of the extension smart contract;
in response to determining that the attribute and the method of the object are of the extension smart contract, calling the extension smart contract instead of the original smart contract; and
executing the extension smart contract.

2. The method of claim 1, further comprising generating the original smart contract such that the original smart contract supports delegation constructs, wherein the original smart contract delegates execution of the method to the extension smart contract.

3. The method of claim 1, wherein the execution environment supports an Interface Definition Language (IDL), allowing an invocation of either the original smart contract or the extension smart contract based on a particular interface definition employed, the attribute, and the method of the call.

4. The method of claim 1, wherein the original smart contract is written in a first programming language and the extension smart contract is written in a second programming language.

5. The method of claim 1, wherein the extension smart contract is comprised in a plurality of extension smart contracts that each uniquely modify functionality of the original smart contract.

6. The method of claim 5, wherein the plurality of extension smart contracts are a chain of extension smart contracts that delegate to each other.

7. The method of claim 1, further comprising calling the extension smart contract instead of the original smart contract further in response to determining that the attribute and the method are not of the original smart contract.

8. The method of claim 1, further comprising calling the extension smart contract instead of the original smart contract further in response to determining that a time period for executing the original smart contract has expired.

9. A system for updating smart contract functionality in a blockchain network, the system comprising:
a hardware processor configured to:
identify, by an execution environment, an original smart contract stored on the blockchain network;
upload an extension smart contract amending functionality of the original smart contract onto the blockchain network, wherein the extension smart contract does not change the original smart contract;
in response to detecting a call to the original smart contract, wherein the call comprises an attribute and method associated with an object, determine whether the attribute and the method are of the extension smart contract;
in response to determining that the attribute and the method of the object are of the extension smart contract, call the extension smart contract instead of the original smart contract; and
execute the extension smart contract.

10. The system of claim 9, wherein the hardware processor is further configured to generate the original smart contract such that the original smart contract supports delegation constructs, wherein the original smart contract delegates execution of the method to the extension smart contract.

11. The system of claim 9, wherein the execution environment supports an Interface Definition Language (IDL), allowing an invocation of either the original smart contract or the extension smart contract based on a particular interface definition employed, the attribute, and the method of the call.

12. The system of claim 9, wherein the original smart contract is written in a first programming language and the extension smart contract is written in a second programming language.

13. The system of claim 9, wherein the extension smart contract is comprised in a plurality of extension smart contracts that each uniquely modify functionality of the original smart contract.

14. The system of claim 13, wherein the plurality of extension smart contracts are a chain of extension smart contracts that delegate to each other.

15. The system of claim 9, wherein the hardware processor is further configured to call the extension smart contract instead of the original smart contract further in response to determining that the attribute and the method are not of the original smart contract.

16. The system of claim 9, wherein the hardware processor is further configured to call the extension smart contract instead of the original smart contract further in response to determining that a time period for executing the original smart contract has expired.

17. A non-transitory computer readable medium storing thereon computer executable instructions for updating smart contract functionality in a blockchain network, including instructions for:
identifying, by an execution environment, an original smart contract stored on the blockchain network;
uploading an extension smart contract amending functionality of the original smart contract onto the blockchain network, wherein the extension smart contract does not change the original smart contract;
in response to detecting a call to the original smart contract, wherein the call comprises an attribute and method associated with an object, determining whether the attribute and the method are of the extension smart contract;
in response to determining that the attribute and the method of the object are of the extension smart contract, calling the extension smart contract instead of the original smart contract; and
executing the extension smart contract.

18. The non-transitory computer readable medium of claim 17, further comprising instructions for generating the original smart contract such that the original smart contract supports delegation constructs, wherein the original smart contract delegates execution of the method to the extension smart contract.

19. The non-transitory computer readable medium of claim 17, wherein the execution environment supports an Interface Definition Language (IDL), allowing an invocation of either the original smart contract or the extension smart contract based on a particular interface definition employed, the attribute, and the method of the call.

20. The non-transitory computer readable medium of claim 17, wherein the original smart contract is written in a first programming language and the extension smart contract is written in a second programming language.
